(19) United States
(12) Patent Application Publication
(10) Pub. No.: US 2025/0196484 A1
(43) Pub. Date: Jun. 19, 2025

(54) MULTILAYER STRUCTURE BASED ON RECYCLED POLYAMIDE

(71) Applicant: ARKEMA FRANCE, Colombes (FR)

(72) Inventors: Marjorie MARCOURT, SERQUIGNY (FR); Thomas PRENVEILLE, SERQUIGNY (FR); Bertrand VERBAUWHEDE, SERQUIGNY (FR); Thierry VASSELIN, Tokyo (JP); Thibaut MONTANARI, SERQUIGNY (FR); Pierre NIDERCORN, GRINDORFF BIZING (FR)

(73) Assignee: ARKEMA FRANCE, Colombes (FR)

(21) Appl. No.: 18/851,632

(22) PCT Filed: Mar. 27, 2023
(86) PCT No.: PCT/FR2023/050431

§ 371 Date: Sep. 26, 2024

(30) Foreign Application Priority Data
Mar. 29, 2022 (FR) FR2202781

(51) Int. Cl. B32B 27/34; B32B 1/08; B32B 27/08; B32B 27/22

(52) U.S. Cl. CPC B32B 27/34; B32B 1/08; B32B 27/08; B32B 27/22; B32B 2250/02; B32B 2250/24; B32B 2270/00; B32B 2272/00; B32B 2307/30; B32B 2307/704; B32B 2597/00; B32B 2605/00

(57) ABSTRACT

A multilayer tubular structure intended for the transportation of motor vehicle fluids, having two layers: a layer (1) of a composition predominantly including at least one semicrystalline aliphatic polyamide, the composition having at least 50% of recycled material originating from a monolayer and/or multilayer tube having been intended for the transportation of motor vehicle fluids, the tube having a composition which includes at least one polyamide, the tube having undergone various treatments in order to be able to be recycled, a layer (2) of a composition including at least one semicrystalline aliphatic polyamide and optionally at least one impact modifier, and, when the layer (2) is a composition including at least one semicrystalline aliphatic polyamide which is PA12 and/or PA612 and/or PA1010, then the composition includes the impact modifier, and the layer (2) is at least 90% of nonrecycled material.

Every year, several million motor vehicles become end-of-life worldwide. An end-of-life motor vehicle (ELV) contains numerous toxic and polluting (liquid or solid) products: drain oil, batteries, air-conditioning fluid, explosive elements of the airbags, and the like. When processed under unsuitable conditions, this waste can result in ground and water pollution, and also in accidents. ELVs are thus regarded as hazardous waste.

A large amount of components of the vehicle can be recovered and recycled, in the form of second-hand spare parts or of raw materials. Parts intended for reuse (headlamps, indicators, engine, radiator, starter, hood, fenders, doors, and the like) are dismantled and stored for resale.

Nonrecyclable hulks and parts (ferrous and nonferrous metals, plastics, glass, rubber, the like) are ground in order to be repurposed thereby or landfilled.

The European Directive 2000/53/EC on end-of-life vehicles set a reuse and repurposing level of 95% by weight per vehicle from 2015.

This means that only 5% should remain as ultimate waste, that is to say waste which is unfit for processing under current technical and economic conditions, and which will be incinerated or disposed of in special landfill sites.

The 95% which are reused and repurposed form the object of:
Energy recovery: use of waste (oils, tires, plastics, and the like) as means for the production of energy, by direct incineration with or without other waste;
Material repurposing: Reuse or re-employment: further employment of a part which retains the same usage and is not transformed, or recycling: operation targeted at introducing materials originating from waste into the production cycle, in complete or partial replacement of a virgin material.

A motor vehicle contains a large number of pipes, in particular pipes intended for the transportation of fluids, such as air, oil (for example for cooling the automatic gearbox (transmission oil cooler or TOC)), water, a urea solution, a glycol-based coolant or a fuel, such as gasoline, in particular biogasoline, or diesel, in particular biodiesel, or hydrogen.

These pipes can be monolayer and/or multilayer tubular structures, in particular based on polyamide(s).

When the motor vehicle is end-of-life, the various pipes present therein are generally very or too degraded to be able to be reused as such, in tube form, without risk or without this resulting in excessively degraded working properties.

This is because the tubes, in particular under engine hoods, are placed in a severe thermo-oxidative environment due to the heat given off by the engine, which can typically reach 150° C., and to the presence of air and thus of oxygen. Each 10° C. increase in temperature typically results in a halving of the lifetime of the tubes, as well as the degradation of certain additives of said tubes, such as stabilizers.

In addition, a pipe for the transportation of a fuel, for example a polyamide pipe which contains a plasticizer, has lost most of its plasticizer when it arrives at the end of its life and the polyamide constituting it initially present is depolymerized and/or degraded and has lost most of its stabilizers, which prohibits it from being reused without risk.

Hitherto, the end-of-life motor vehicle pipe is not reused and is often incinerated but this then contributes to global warming, the reduction of which is becoming one of the major challenges of the 21st century.

Moreover, several motor vehicle manufacturers have the more or less long-term objective of recycling 100% of the vehicles which they produce, so as to achieve an environmental impact equal to zero.

Consequently, the provision of recycled pipes to these manufacturers is becoming essential and then makes it possible to reduce the amount of pipes to be discarded or incinerated.

The present invention thus relates to a multilayer tubular structure (MLT) intended for the transportation of motor vehicle fluids, in particular of air, oil, water, a urea solution, a glycol-based coolant or a fuel, such as gasoline, in particular alcohol-blended gasoline or biogasoline, or diesel, in particular biodiesel, or hydrogen, consisting of two layers:
a layer (1) consisting of a composition predominantly comprising at least one semicrystalline aliphatic polyamide, said composition consisting of at least 50% of recycled material originating from a monolayer and/or multilayer tube having been intended for the transportation of motor vehicle fluids, in particular as defined above, said tube consisting of a composition which predominantly comprises at least one polyamide,
said tube having undergone various treatments chosen from a grinding and then a recompounding, and a grinding and then a recompounding and subsequently a reformulation in order to be able to be recycled,
a simple single grinding being excluded from the various treatments,
a layer (2) consisting of a composition predominantly comprising at least one semicrystalline aliphatic polyamide and optionally at least one impact modifier,
and, when the layer (2) consists of a composition predominantly comprising at least one semicrystalline aliphatic polyamide which is PA12 or PA612 or PA1010, then said composition comprises said impact modifier, and
said layer (2) consisting of at least 90% of nonrecycled material.

The inventors have thus found, surprisingly, that a polyamide-based layer consisting of at least 50% of recycled material, in contact with a polyamide layer consisting of nonrecycled material, makes possible the formation of a multilayer tubular structure capable of transporting a motor vehicle fluid, in particular air, oil, water, a urea solution, a glycol-based coolant or a fuel, such as gasoline, in particular biogasoline, or diesel, in particular biodiesel, or hydrogen, this being the case whatever the type of fluid initially transported by the constituent recycled monolayer and/or multilayer tube of the layer in contact with the transported fluid, said multilayer structure exhibiting, contrary to all expectations, much better properties than those of the same tubular structure, the polyamide-based layer (1) consisting of at least 50% of recycled material of which is of simply ground origin.

During the use, in motor vehicles, of tubes for the transportation or the storage of fluids, new entities resulting from mechanisms of oxidations, in particular of amide functions and/or of methylene in the alpha position with respect to said amide functions, such as imide, carboxylic acid, primary amide and alcohol functions, appear in the polyamides constituting said tubes or tanks. Said functions can be detected by infrared spectrometry.

Thus, the absorption band from 1700 to 1740 cm⁻¹ corresponds to an imide, that from 1680 to 1720 cm⁻¹ corresponds to the carbonyl of the carboxylic acid and that from 3580 to 3670 cm⁻¹ corresponds to the alcohol function of the carboxylic acid.

The absorption band from 3580 to 3670 cm⁻¹ corresponds to the free alcohol function.

The amide function is characterized, on the one hand, by a pair of absorption bands from 3100 to 3500 cm⁻¹ and from 1560 to 1640 cm⁻¹ which corresponds to the NH group of the amide and, on the other hand, by the absorption band from 1650 to 1700 cm⁻¹ which corresponds to the carbonyl group of the amide.

In one embodiment, said polyamide of said monolayer and/or multilayer tube having been intended for the transportation of motor vehicle fluids, or also used tube, exhibits functions resulting from oxidation reactions chosen from imide, carboxylic acid and alcohol functions and their mixtures, in a molar ratio, with respect to the amide functions, which is greater than that of the same polyamide constituting an unused tube which has never yet transported motor vehicle fluids.

Advantageously, said molar ratio of the functions resulting from oxidation reactions is of from 1/10 000 to 1/20.

The concentrations can be measured by proton NMR in dichloromethane-d2, HFIP (hexafluoroisopropanol) being added in order to dissolve the polyamide.

In a first alternative form, said molar ratio of the imide functions is of from 1/1000 to 1/20, in particular from 1/500 to 1/20, especially from 1/200 to 1/50.

In a second alternative form, said molar ratio of the carboxylic acid functions is of from 1/5000 to 1/20, in particular from 1/3000 to 1/25, very advantageously of from 1/500 to 1/50.

In a third alternative form, said molar ratio of the alcohol functions is of from 1/1000 to 1/20, advantageously of from 1/1000 to 1/25, very advantageously of from 1/200 to 1/50.

In one embodiment, said tubular structure exhibits, during the first storage of gasoline, in particular of alcohol-blended gasoline, a maximum of 0.3 g/m² of insoluble extract, advantageously a maximum of 0.2 g/m².

In one embodiment, said tubular structure exhibits, during the first storage of gasoline, in particular of alcohol-blended gasoline, 30%, in particular 40%, especially 50%, less insoluble extract than the same tubular structure resulting from nonrecycled material.

The monolayer tubular structure of the invention intended for the transportation of motor vehicle fluids makes it possible to greatly reduce the proportion of extractables as determined by a test which consists in filling a tubular structure with alcohol-blended gasoline of FAM-B type, in heating the assembly at 60° C. for 96 hours and in then emptying it by filtering the fluid into a beaker.

The insoluble extracts present during the filtration on the filter are weighed after drying and represent less than 0.3 g/m².

The soluble extracts are quantified by allowing the filtrate from the beaker to evaporate at ambient temperature and then by weighing this residue. The proportion of soluble extracts is advantageously less than or equal to approximately 15 g/m² of tube internal surface.

Said tubular structure exhibits an extractables content which is lower than that of the same tubular structure resulting from nonrecycled, that is to say virgin or original, material during the first storage of gasoline, in particular of alcohol-blended gasoline, and in particular a proportion of insoluble extract which is lower by 30%, in particular by 40%, especially by 50%, with respect to the proportion present in the same tubular structure but resulting from nonrecycled or virgin material.

The tubular structure also advantageously comprises residues of stabilizers chosen from phenols, quinones, stilbenequinones and phosphite.

The recycled polyamide advantageously comprises alkyl chain ends with a carbon number, of from 1 to 18, which is greater than that of a virgin PA.

Advantageously, the content of chain ends is of between 1 ppm and 0.5%, as determined by NMR or potentiometry.

Used polyamide (to be recycled) is more crystalline than virgin polyamide.

The percentage of crystallization can be measured by DSC (or by X-ray).

Advantageously, the used polyamide exhibits a degree of crystallinity greater by at least 2%, in particular by at least 5%, than that of a virgin polyamide, as measured by DSC.

The term “fluid” denotes a gas or a liquid used in a motor vehicle, in particular air, oil, water, a urea solution, a glycol-based coolant or a fuel, such as gasoline, in particular alcohol-blended gasoline or biogasoline, or diesel, in particular biodiesel, or hydrogen.

Advantageously, said fluid denotes fuels, in particular gasoline, in particular alcohol-blended gasoline or biogasoline, or diesel, in particular biodiesel.

The term “gasoline” denotes a mixture of hydrocarbons resulting from the distillation of petroleum, to which additives or alcohols, such as methanol and ethanol, can be added, it being possible for the alcohols to be predominant components in some cases.

The expression “alcohol-blended gasoline” denotes a gasoline to which methanol or ethanol has been added. It also denotes a gasoline of E95 type, which does not contain a product from the distillation of petroleum.

The expression “polyamide-based” means at least 50% by weight of polyamide in the layer.

The expression “a composition predominantly comprising at least one polyamide . . . ” means at least 50% by weight of said polyamide in the composition.

In one embodiment, said layer (2) consists of a composition predominantly comprising at least one semicrystalline aliphatic polyamide and at least one impact modifier in a proportion of from 3% to 45% by weight, with respect to the total weight of the composition.

### As Regards the Layer (1)

The layer (1) consists of a composition predominantly comprising at least one semicrystalline aliphatic polyamide, said composition consisting of at least 50% of recycled material originating from a monolayer and/or multilayer tube which has been intended for the transportation of motor vehicle fluids.

The nomenclature used to define polyamides is described in the standard ISO 1874-1:2011 “Plastics-Polyamide (PA) moulding and extrusion materials—Part 1: Designation” and is well known to a person skilled in the art.

The term “polyamide” according to the invention just as equally denotes a homopolyamide as a copolyamide.

Within the meaning of the invention, the term “semicrystalline polyamide”, throughout the description, denotes polyamides which exhibit a melting point (Tm) and an enthalpy of fusion ΔH>25 J/g, especially >40 J/g, in particular >45 J/g, and also a glass transition temperature (Tg) as are determined by DSC according to the standards ISO 11357-1:2016 and ISO 11357-2 and 3:2013, at a heating rate of 20 K/min.

Said at least one semicrystalline aliphatic polyamide is obtained from the polycondensation of at least one lactam, or from the polycondensation of at least one amino acid, or from the polycondensation of at least one diamine Xa with at least one dicarboxylic acid Yb.

When said at least one semicrystalline aliphatic polyamide is obtained from the polycondensation of at least one lactam, said at least one lactam can be chosen from a C₆ to C₁₈, preferentially C₁₀ to C₁₈, more preferentially C₁₀ to C₁₂, lactam. A C₆ to C₁₂ lactam is in particular caprolactam, decanolactam, undecanolactam or lauryllactam.

When said at least one semicrystalline aliphatic polyamide is obtained from the polycondensation of at least one lactam, it can thus comprise a single lactam or several lactams.

Advantageously, said at least one semicrystalline aliphatic polyamide is obtained from the polycondensation of a single lactam and said lactam is chosen from lauryllactam and undecanolactam, advantageously lauryllactam.

When said at least one semicrystalline aliphatic polyamide is obtained from the polycondensation of at least one amino acid, said at least one amino acid can be chosen from a C₆ to C₁₈, preferentially C₁₀ to C₁₈, more preferentially C₁₀ to C₁₂, amino acid.

A C₆ to C₁₂ amino acid is in particular 6-aminohexanoic acid, 9-aminononanoic acid, 10-aminodecanoic acid, 10-aminoundecanoic acid, 12-aminododecanoic acid and 11-aminoundecanoic acid and also its derivatives, in particular N-heptyl-11-aminoundecanoic acid.

When said at least one semicrystalline aliphatic polyamide is obtained from the polycondensation of at least one amino acid, it can thus comprise a single amino acid or several amino acids.

Advantageously, said semicrystalline aliphatic polyamide is obtained from the polycondensation of a single amino acid and said amino acid is chosen from 11-aminoundecanoic acid and 12-aminododecanoic acid, advantageously 11-aminoundecanoic acid.

When said at least one semicrystalline aliphatic polyamide is obtained from the polycondensation of at least one C₄-C₃₆, preferentially C₅-C₁₈, preferentially C₅-C₁₂, more preferentially C₁₀-C₁₂, diamine Xa with at least one C₄-C₃₆, preferentially C₆-C₁₈, preferentially C₆-C₁₂, more preferentially C₁₀-C₁₂, diacid Yb, then said at least one diamine Xa is an aliphatic diamine and said at least one diacid Yb is an aliphatic diacid.

The diamine can be linear or branched. Advantageously, it is linear.

Said at least one C₄-C₃₆ diamine Xa can be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine Xa is a C₅-C₁₈ diamine and is chosen from 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C₅-C₁₂ diamine Xa is chosen in particular from 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, said at least one C₆ to C₁₂ diamine Xa is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine Xa used is a C₁₀ to C₁₂ diamine, in particular chosen from 1,10-decamethylenediamine, 1,11-undecamethylenediamine and 1,12-dodecamethylenediamine.

Said at least one C₄ to C₃₆ dicarboxylic acid Yb can be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid and diacids obtained from fatty acids.

The diacid can be linear or branched. Advantageously, it is linear.

Advantageously, said at least one dicarboxylic acid Yb is a C₆ to C₁₈ dicarboxylic acid and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Yb is a C₆ to C₁₂ dicarboxylic acid and is chosen from adipic acid, suberic acid, azelaic acid, sebacic acid, undecanedioic acid and dodecanedioic acid.

Advantageously, said at least one dicarboxylic acid Yb is a C₁₀ to C₁₂ dicarboxylic acid and is chosen from sebacic acid, undecanedioic acid and dodecanedioic acid.

When said semicrystalline aliphatic polyamide is obtained from the polycondensation of at least one diamine Xa with at least one dicarboxylic acid Yb, it can thus comprise a single diamine or several diamines and a single dicarboxylic acid or several dicarboxylic acids.

Advantageously, said semicrystalline aliphatic polyamide is obtained from the polycondensation of a single diamine Xa with a single dicarboxylic acid Yb.

The term “predominantly comprising at least one polyamide of aliphatic type” means that said composition of the layer (1) comprises at least 50% by weight of at least one aliphatic polyamide, with respect to the total weight of said composition.

Advantageously, said composition of the layer (1) comprises at least 60% by weight, in particular at least 70% by weight, especially at least 80% by weight, more particularly at least 90% by weight, of at least one aliphatic polyamide, with respect to the total weight of said composition.

The composition of the layer (1) consists of at least 50% of recycled material originating from a monolayer and/or multilayer tube having been intended for the transportation of motor vehicle fluids.

This means either that the “at least one predominant polyamide” of said composition corresponds in its entirety to what is referred to as “at least 50% of recycled material”, or that at least 50% by weight of all of the constituents of the composition are of recycled origin originating from a monolayer tube, or a multilayer tube, or a mixture of monolayer and multilayer tubes.

The recycled material can originate from a monolayer and/or multilayer tube, said monolayer and/or multilayer tubes having been intended for the transportation of motor vehicle fluids. Said tube is thus a used tube, that is to say that it has been used for at least one year for the transportation of said fluid defined above. Said monolayer tube consists of a composition comprising a semicrystalline aliphatic polyamide and optionally impact modifiers and/or additives and/or plasticizers and/or antistatic fillers.

Said multilayer tube comprises at least one layer consisting of a composition comprising a semicrystalline aliphatic polyamide and optionally impact modifiers and/or additives. It can thus comprise other layers consisting of a thermoplastic polymer other than a semicrystalline aliphatic polyamide, such as, for example, a polypropylene, a semiaromatic polyamide or a poly(ethylene-vinyl alcohol) (EVOH).

It is very obvious that the monolayer tube can also be a monolayer tube mixture, that is to say, for example, a mixture of two types of monolayer tubes each consisting of a different semicrystalline aliphatic polyamide, for example a PA11 and a PA12.

It is also very obvious that the multilayer tube can also be a mixture of different multilayer tube types, provided that at least one of the layers of one of the multilayer tube types consists of a semicrystalline aliphatic polyamide.

If the mixed tubes are mutually incompatible, then the addition of a second semicrystalline aliphatic polyamide denoted B and exhibiting a mean number of carbon atoms per nitrogen atom denoted C_{B}=C_{C}−1, preferentially C_{B}=C_{C}−2, and preferably of a third polyamide, makes it possible to render them compatible.

Said monolayer and/or multilayer tube, which was intended for the transportation of motor vehicle fluids and which is thus used, can be subjected to several different treatments in order to be able to be recycled:
it can be ground and recompounded, that is to say that, after grinding, the ground particles are fed into an extruder, in particular of corotating twin-screw type or of co-kneader (Buss) type, where they are remixed by melting. The molten material exits the extruder as rods which are cooled and cut into granules;
It can be ground and recompounded and reformulated, that is to say that, after grinding, the ground particles are fed into an extruder as defined above where they are remixed by melting with the addition of at least one compound chosen from a semicrystalline aliphatic polyamide, of recycled or nonrecycled origin, of at least one impact modifier, of a plasticizer, of an additive and of antistatic fillers. The molten material exits the extruder as rods which are cooled and cut into granules.

A tube which is simply ground is thus excluded from said used monolayer and/or multilayer tube which was intended for the transportation of motor vehicle fluids.

Optionally, the monolayer and/or multilayer tube which was intended for the transportation of motor vehicle fluids is subjected to a washing and/or cleaning stage before grinding.

Optionally, the ground tube is subjected to a washing and/or cleaning stage after grinding.

Optionally, the monolayer and/or multilayer tube which was intended for the transportation of motor vehicle fluids is subjected to a washing and/or cleaning stage before grinding and is then ground and it is then optionally subjected, before the recompounding, to a washing and/or cleaning stage after grinding.

The cleaning stage can be carried out, for example, under vacuum.

In one embodiment, said composition of the layer (1) comprises:
at least 50% by weight, especially from 50% to 99% by weight, in particular from 50% to 98% by weight, of at least one semicrystalline aliphatic polyamide, denoted C, exhibiting a mean number of carbon atoms per nitrogen atom, denoted C_{C}, of from 6 to 18, advantageously from 8 to 12;
from 0% to 50% by weight of at least one semicrystalline aliphatic polyamide denoted B and exhibiting a mean number of carbon atoms per nitrogen atom denoted C_{B}═C_{C}-1, preferentially C_{B}=C_{C}−2;
from 0% to 50% by weight of a semicrystalline aliphatic polyamide denoted A and exhibiting a mean number of carbon atoms per nitrogen atom denoted C_{A}=C_{B}−1, preferentially C_{A}=C_{B}−2;
from 0% to 45% by weight of at least one impact modifier, especially from 1% to 45% by weight of at least one impact modifier, in particular from 2% to 45% by weight of at least one impact modifier;
from 0% to 20% by weight of at least one plasticizer;
from 0% to 2% by weight of at least one additive;
the sum of the constituents being equal to 100%.

In another embodiment, said composition of the layer (1) consists of:
at least 50% by weight, especially from 50% to 99% by weight, in particular from 50% to 98% by weight, of at least one semicrystalline aliphatic polyamide, denoted C, exhibiting a mean number of carbon atoms per nitrogen atom, denoted C_{C}, of from 6 to 18, advantageously from 8 to 12;
from 0% to 25% by weight of at least one semicrystalline aliphatic polyamide denoted B and exhibiting a mean number of carbon atoms per nitrogen atom denoted C_{B}=C_{C}−1, preferentially C_{B}=C_{C}−2;
from 0% to 25% by weight of a semicrystalline aliphatic polyamide denoted A and exhibiting a mean number of carbon atoms per nitrogen atom denoted C_{A}=C_{B}−1, preferentially C_{A}=C_{B}−2;
from 0% to 45% by weight of at least one impact modifier, especially from 1% to 45% by weight of at least one impact modifier, in particular from 2% to 45% by weight of at least one impact modifier;
from 0% to 20% by weight of at least one plasticizer;
from 0% to 2% by weight of at least one additive;
the sum of the constituents being equal to 100%.

In yet another embodiment, said composition of the layer (1) comprises:
at least 50% by weight, in particular from 50% to 97% by weight, of at least one semicrystalline aliphatic polyamide, denoted C, exhibiting a mean number of carbon atoms per nitrogen atom, denoted C_{C}, of from 6 to 18, advantageously from 8 to 12;
from 0% to 25% by weight of at least one semicrystalline aliphatic polyamide denoted B and exhibiting a mean number of carbon atoms per nitrogen atom denoted C_{B}=C_{C}−1, preferentially C_{B}=C_{C}−2;
from 0% to 25% by weight of a semicrystalline aliphatic polyamide denoted A and exhibiting a mean number of carbon atoms per nitrogen atom denoted C_{A}=C_{B}−1, preferentially C_{A}=C_{B}−2;
from 0% to 45% by weight of at least one impact modifier, in particular from 3% to 45% by weight of at least one impact modifier;
from 0% to 20% by weight of at least one plasticizer;
from 0% to 2% by weight of at least one additive;
the sum of the constituents being equal to 100%.

The polyamides denoted A, B and C can be of recycled or nonrecycled origin, provided that the composition of the layer (1) consists of at least 50% of recycled material.

Advantageously, the Tm of the predominant semicrystalline aliphatic polyamide of the layer (1) is ≤225° C., in particular ≤200° C., as determined according to ISO 11357-3:2013, at a heating rate of 20 K/min.

Advantageously, the predominant semicrystalline aliphatic polyamide of the layer (1) exhibits an enthalpy of crystallization ≥25 J/g, preferentially ≥40 J/g, in particular ≥45 J/g, as determined by DSC according to the standard ISO 11357-3:2013, at a heating rate of 20 K/min.

In one embodiment, the recycled material originates from a monolayer and/or multilayer tube chosen from a ground and recompounded monolayer and/or multilayer tube and a ground, recompounded and reformulated monolayer and/or multilayer tube.

Advantageously, in this embodiment, said composition of the layer (1) is devoid of plasticizer and/or of impact modifier and said recycled material originates from a monolayer and/or multilayer tube chosen from a ground and recompounded monolayer and/or multilayer tube and a ground, recompounded and reformulated monolayer and/or multilayer tube.

In one embodiment, said composition of the layer (1) is devoid of plasticizer and/or of impact modifier and said recycled material originates from a tube chosen from a ground and recompounded tube and a ground, recompounded and reformulated tube.

In another embodiment, said composition of the layer (1) comprises at least one compound chosen from a plasticizer, an impact modifier and an additive, and said recycled material is chosen from a ground, then recompounded and reformulated, tube.

Advantageously, in these last two embodiments, said tube is a monolayer tube and/or a multilayer tube.

In one embodiment, the fluid transported by said monolayer and/or multilayer tube is different from that of said multilayer tubular structure (MLT).

This means that, if the monolayer and/or multilayer tube has transported a fluid such as air, said multilayer tubular structure (MLT) may be intended to transport gasoline or also that, if the monolayer and/or multilayer tube has transported a fluid such as alcohol-blended gasoline, said multilayer tubular structure (MLT) may be intended to transport diesel.

In another embodiment, the fluid transported by said monolayer and/or multilayer tube is the same as that of said multilayer tubular structure (MLT).

This means that if the monolayer and/or multilayer tube has transported a fluid such as gasoline, said tubular structure (MLT) may be intended to transport gasoline, provided that the gasoline of the monolayer and/or multilayer tube and of said multilayer tubular structure (MLT) is the same, for example alcohol-blended gasoline.

Advantageously, the recycled material originates from a monolayer tube consisting of a composition comprising solely a PA11.

In one embodiment, said composition of the layer (1) comprises at least 60% by weight, in particular at least 70% by weight, in particular at least 80% by weight, especially at least 90% by weight, more particularly at least 95% by weight, of recycled material.

In another embodiment, said composition of the layer (1) consists of 100% by weight of recycled material.

### Recycled Used Monolayer or Multilayer Tube

In a first alternative form, said tube which was intended for the transportation of motor vehicle fluids is monolayer or multilayer, ground and recompounded, and the composition of the layer (1) resulting from said recycling consists of:
at least 61% by weight, especially from 96% to 99% by weight, in particular from 96% to 98% by weight, of at least one semicrystalline aliphatic polyamide, denoted C, exhibiting a mean number of carbon atoms per nitrogen atom, denoted C_{C}, of from 6 to 18, advantageously from 8 to 12;
from 0% to 2% by weight of at least one plasticizer;
from 0% to 2% by weight of at least one additive, in particular a stabilizer;
the sum of the constituents being equal to 100%.

Advantageously, in this first alternative form, the semicrystalline aliphatic polyamide denoted C is chosen from PA612, PA1012, PA1010, PA11 and PA12, in particular PA11.

Advantageously, in this first alternative form, said tube was intended for the transportation of fuels, such as gasoline, in particular alcohol-blended gasoline or biogasoline, or diesel, in particular biodiesel.

Advantageously, in this first alternative form, the semicrystalline aliphatic polyamide denoted C is chosen from PA612, PA1012, PA1010, PA11 and PA12, in particular PA11, and said tube was intended for the transportation of fuels, such as gasoline, in particular alcohol-blended gasoline or biogasoline, or diesel, in particular biodiesel.

Advantageously, said tube which was intended for the transportation of motor vehicle fluids is a monolayer tube.

In a second alternative form, said tube which was intended for the transportation of motor vehicle fluids is monolayer or multilayer, ground, recompounded and reformulated, and the composition of the layer (1) resulting from said recycling and reformulated consists of:
at least 58.5% by weight of at least one semicrystalline aliphatic polyamide, denoted C, exhibiting a mean number of carbon atoms per nitrogen atom, denoted C_{C}, of from 6 to 18, advantageously from 8 to 12;
from 6% to 14% of at least one plasticizer, in particular from 6% to 8%;
from 0.5% to 1.5% by weight of at least one additive, in particular a stabilizer;
the sum of the constituents being equal to 100%.

Advantageously, in this second alternative form, the semicrystalline aliphatic polyamide denoted C is chosen from PA612, PA1012, PA1010, PA11 and PA12, in particular PA11.

Advantageously, in this second alternative form, said tube was intended for the transportation of fuels, such as gasoline, in particular alcohol-blended gasoline or biogasoline, or diesel, in particular biodiesel.

Advantageously, in this second alternative form, the semicrystalline aliphatic polyamide denoted C is chosen from PA612, PA1012, PA1010, PA11 and PA12, in particular PA11, and said tube was intended for the transportation of fuels, such as gasoline, in particular alcohol-blended gasoline or biogasoline, or diesel, in particular biodiesel.

Advantageously, said tube which was intended for the transportation of motor vehicle fluids is a monolayer tube.

In a third alternative form, said tube which was intended for the transportation of motor vehicle fluids is monolayer or multilayer, ground, recompounded and reformulated, and the composition of the layer (1) resulting from said recycling and reformulated consists of:
at least 58% by weight of at least one semicrystalline aliphatic polyamide, denoted C, exhibiting a mean number of carbon atoms per nitrogen atom, denoted C_{C}, of from 6 to 18, advantageously from 8 to 12;
from 6% to 14% of at least one plasticizer, in particular from 6% to 8%;
from 1% to 2% by weight of at least one additive, in particular a stabilizer and a catalyst;
the sum of the constituents being equal to 100%.

Advantageously, in this third alternative form, the semicrystalline aliphatic polyamide denoted C is chosen from PA612, PA1012, PA1010, PA11 and PA12, in particular PA11.

Advantageously, in this third alternative form, said tube was intended for the transportation of fuels, such as gasoline, in particular alcohol-blended gasoline or biogasoline, or diesel, in particular biodiesel.

Advantageously, in this third alternative form, the semicrystalline aliphatic polyamide denoted C is chosen from PA612, PA1012, PA1010, PA11 and PA12, in particular PA11, and said tube was intended for the transportation of fuels, such as gasoline, in particular alcohol-blended gasoline or biogasoline, or diesel, in particular biodiesel.

Advantageously, said tube which was intended for the transportation of motor vehicle fluids is a monolayer tube.

Advantageously, the composition is degassed during the compounding; more advantageously still, the degassing is located just after the melting zone and before the zone of introduction of plasticizer, such as BBSA or the like.

In a fourth alternative form, said tube which was intended for the transportation of motor vehicle fluids is monolayer or multilayer, ground, recompounded and reformulated, and the composition of the layer (1) resulting from said recycling and reformulated consists of:
at least 50% by weight, especially from 50% to 99% by weight, in particular from 50% to 98% by weight, of at least one semicrystalline aliphatic polyamide, denoted C, exhibiting a mean number of carbon atoms per nitrogen atom, denoted C_{C}, of from 6 to 18, advantageously from 8 to 12;
from 0% to 25% by weight of at least one semicrystalline aliphatic polyamide denoted B and exhibiting a mean number of carbon atoms per nitrogen atom denoted C_{B}=C_{C}−1, preferentially C_{B}=C_{C}−2;
from 0% to 25% by weight of a semicrystalline aliphatic polyamide denoted A and exhibiting a mean number of carbon atoms per nitrogen atom denoted C_{A}=C_{B}−1, preferentially C_{A}=C_{B}−2;
from 0% to 2% by weight of at least one plasticizer;
from 0% to 2% by weight of at least one additive;
the sum of the constituents being equal to 100%.

Advantageously, in this fourth alternative form, the semicrystalline aliphatic polyamide denoted C is chosen from PA612, PA1012, PA1010, PA11 and PA12, in particular PA11.

Advantageously, in this fourth alternative form, said tube was intended for the transportation of fuels, such as gasoline, in particular alcohol-blended gasoline or biogasoline, or diesel, in particular biodiesel.

Advantageously, in this fourth alternative form, the semicrystalline aliphatic polyamide denoted C is chosen from PA612, PA1012, PA1010, PA11 and PA12, in particular PA11, and said tube was intended for the transportation of fuels, such as gasoline, in particular alcohol-blended gasoline or biogasoline, or diesel, in particular biodiesel.

Advantageously, said tube which was intended for the transportation of motor vehicle fluids is a monolayer tube.

In a fifth alternative form, said tube which was intended for the transportation of motor vehicle fluids is monolayer or multilayer, ground, recompounded and reformulated, and the composition of the layer (1) resulting from said recycling and reformulated consists of:
at least 55% by weight, especially from 55% to 99% by weight, in particular from 55% to 98% by weight, of at least one semicrystalline aliphatic polyamide, denoted C, exhibiting a mean number of carbon atoms per nitrogen atom, denoted C_{C}, of from 6 to 18, advantageously from 8 to 12;
from 0% to 45% by weight of at least one impact modifier, especially from 1% to 45% by weight of at least one impact modifier, in particular from 2% to 45% by weight of at least one impact modifier;
the sum of the constituents being equal to 100%.

Advantageously, in this fifth alternative form, the semicrystalline aliphatic polyamide denoted C is chosen from PA612, PA1012, PA1010, PA11 and PA12, in particular PA11.

Advantageously, in this fifth alternative form, said tube was intended for the transportation of fuels, such as gasoline, in particular alcohol-blended gasoline or biogasoline, or diesel, in particular biodiesel.

Advantageously, in this fifth alternative form, the semicrystalline aliphatic polyamide denoted C is chosen from PA612, PA1012, PA1010, PA11 and PA12, in particular PA11, and said tube was intended for the transportation of fuels, such as gasoline, in particular alcohol-blended gasoline or biogasoline, or diesel, in particular biodiesel.

Advantageously, said tube which was intended for the transportation of motor vehicle fluids is a monolayer tube.

In a sixth alternative form, said tube which was intended for the transportation of motor vehicle fluids is monolayer or multilayer, ground, recompounded and reformulated, and the composition of the layer (1) resulting from said recycling and reformulated consists of:
at least 50% by weight of at least one semicrystalline aliphatic polyamide, denoted C, exhibiting a mean number of carbon atoms per nitrogen atom, denoted C_{C}, of from 6 to 18, advantageously from 8 to 12;
from 0% to 43.5% by weight of at least one impact modifier, especially from 1% to 43.5% by weight of at least one impact modifier, in particular from 2% to 43.5% by weight of at least one impact modifier;
from 6% to 14% of at least one plasticizer, in particular from 6% to 8%;
from 0.5% to 1.5% by weight of at least one additive, in particular a stabilizer;
the sum of the constituents being equal to 100%.

Advantageously, in this sixth alternative form, the semicrystalline aliphatic polyamide denoted C is chosen from PA612, PA1012, PA1010, PA11 and PA12, in particular PA11.

Advantageously, in this sixth alternative form, said tube was intended for the transportation of fuels, such as gasoline, in particular alcohol-blended gasoline or biogasoline, or diesel, in particular biodiesel.

Advantageously, in this sixth alternative form, the semicrystalline aliphatic polyamide denoted C is chosen from PA612, PA1012, PA1010, PA11 and PA12, in particular PA11, and said tube was intended for the transportation of fuels, such as gasoline, in particular alcohol-blended gasoline or biogasoline, or diesel, in particular biodiesel.

Advantageously, said tube which was intended for the transportation of motor vehicle fluids is a monolayer tube.

In a seventh alternative form, said tube which was intended for the transportation of motor vehicle fluids is monolayer or multilayer, ground, recompounded and reformulated, and the composition of the layer (1) resulting from said recycling and reformulated consists of:
at least 50% by weight of at least one semicrystalline aliphatic polyamide, denoted C, exhibiting a mean number of carbon atoms per nitrogen atom, denoted C_{C}, of from 6 to 18, advantageously from 8 to 12;
from 0% to 43% by weight of at least one impact modifier, especially from 1% to 43% by weight of at least one impact modifier, in particular from 2% to 38% by weight of at least one impact modifier;
from 6% to 14% of at least one plasticizer, in particular from 6% to 8%;
from 1% to 2% by weight of at least one additive, in particular a stabilizer and a catalyst;
the sum of the constituents being equal to 100%.

Advantageously, in this seventh alternative form, the semicrystalline aliphatic polyamide denoted C is chosen from PA612, PA1012, PA1010, PA11 and PA12, in particular PA11.

Advantageously, in this seventh alternative form, said tube was intended for the transportation of fuels, such as gasoline, in particular alcohol-blended gasoline or biogasoline, or diesel, in particular biodiesel.

Advantageously, in this seventh alternative form, the semicrystalline aliphatic polyamide denoted C is chosen from PA612, PA1012, PA1010, PA11 and PA12, in particular PA11, and said tube was intended for the transportation of fuels, such as gasoline, in particular alcohol-blended gasoline or biogasoline, or diesel, in particular biodiesel.

Advantageously, said tube which was intended for the transportation of motor vehicle fluids is a monolayer tube.

In an eighth alternative form, said tube which was intended for the transportation of motor vehicle fluids is monolayer or multilayer, ground, recompounded and reformulated, and the composition of the layer (1) resulting from said recycling and reformulated consists of:
at least 50% by weight of at least one semicrystalline aliphatic polyamide, denoted C, exhibiting a mean number of carbon atoms per nitrogen atom, denoted C_{C}, of from 6 to 18, advantageously from 8 to 12;
from 0% to 25% by weight of at least one semicrystalline aliphatic polyamide denoted B and exhibiting a mean number of carbon atoms per nitrogen atom denoted C_{B}=C_{C}−1, preferentially C_{B}=C_{C}−2;
from 0% to 25% by weight of a semicrystalline aliphatic polyamide denoted A and exhibiting a mean number of carbon atoms per nitrogen atom denoted C_{A}=C_{B}−1, preferentially C_{A}=C_{B}−2;
from 0% to 43% by weight of at least one impact modifier, especially from 1% to 43% by weight of at least one impact modifier, in particular from 2% to 38% by weight of at least one impact modifier;
from 0% to 20% by weight of at least one plasticizer;
from 0% to 2% by weight of at least one additive;
the sum of the constituents being equal to 100%.

Advantageously, in this eighth alternative form, the semicrystalline aliphatic polyamide denoted C is chosen from PA612, PA1012, PA1010, PA11 and PA12, in particular PA11.

Advantageously, in this eighth alternative form, said tube was intended for the transportation of fuels, such as gasoline, in particular alcohol-blended gasoline or biogasoline, or diesel, in particular biodiesel.

Advantageously, in this eighth alternative form, the semicrystalline aliphatic polyamide denoted C is chosen from PA612, PA1012, PA1010, PA11 and PA12, in particular PA11, and said tube was intended for the transportation of fuels, such as gasoline, in particular alcohol-blended gasoline or biogasoline, or diesel, in particular biodiesel.

Advantageously, said tube which was intended for the transportation of motor vehicle fluids is a monolayer tube.

### As Regards the Impact Modifier

The impact modifier advantageously consists of a polymer exhibiting a flexural modulus of less than 100 MPa, measured according to the standard ISO 178:2010, determined at 23° C. with a relative humidity: RH of 50%, and a Tg of less than 0° C. (measured according to the standard 11357-2:2013 at the inflection point of the DSC thermogram, at a heating rate of 20 K/min), in particular a polyolefin.

The polyolefin of the impact modifier can be functionalized or nonfunctionalized or be a blend of at least one which is functionalized and of at least one which is nonfunctionalized. To simplify, the polyolefin has been denoted by (B) and functionalized polyolefins (B1) and nonfunctionalized polyolefins (B2) have been described below.

A nonfunctionalized polyolefin (B2) is conventionally a homopolymer or copolymer of α-olefins or of diolefins, such as, for example, ethylene, propylene, 1-butene, 1-octene or butadiene. Mention may be made, by way of examples, of:
ethylene homopolymers and copolymers, in particular LDPE, HDPE, LLDPE (linear low density polyethylene), VLDPE (very low density polyethylene) and metallocene polyethylene;
propylene homopolymers or copolymers;
ethylene/α-olefin, such as ethylene/propylene, EPR (abbreviation for ethylene-propylene rubber) and ethylene/propylene/diene (EPDM), copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to reach 40% by weight.

The functionalized polyolefin (B1) can be a polymer of α-olefins having reactive units (the functionalities); such reactive units are the acid, anhydride or epoxy functions. Mention may be made, by way of example, of the preceding polyolefins (B2) grafted or co- or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals, such as Zn, and the like), or also with carboxylic acid anhydrides, such as maleic anhydride. A functionalized polyolefin is, for example, a PE/EPR blend, the ratio by weight of which can vary within broad limits, for example between 40/60 and 90/10, said blend being cografted with an anhydride, in particular maleic anhydride, according to a degree of grafting, for example, of from 0.01% to 5% by weight.

The functionalized polyolefin (B1) can be chosen from the following (co) polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/α-olefin, such as ethylene/propylene, EPR (abbreviation for ethylene-propylene rubber) and ethylene/propylene/diene (EPDM), copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene and vinyl acetate (EVA), containing up to 40% by weight of vinyl acetate;
copolymers of ethylene and of alkyl (meth)acrylate, containing up to 40% by weight of alkyl (meth)acrylate;
copolymers of ethylene and of vinyl acetate (EVA) and of alkyl (meth)acrylate, containing up to 40% by weight of comonomers.

The functionalized polyolefin (B1) can also be chosen from ethylene/propylene copolymers, predominant in propylene, grafted with maleic anhydride and then condensed with monoaminated polyamide (or a monoaminated polyamide oligomer) (products described in EP-A-0 342 066).

The functionalized polyolefin (B1) can also be a co- or terpolymer of at least the following units: (1) ethylene, (2) alkyl (meth)acrylate or saturated carboxylic acid vinyl ester and (3) anhydride, such as maleic anhydride, or (meth)acrylic acid or epoxy, such as glycidyl (meth)acrylate.

Mention may be made, by way of examples of functionalized polyolefins of the latter type, of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the copolymers which precede, the (meth)acrylic acid can be salified with Zn or Li.

The term “alkyl (meth)acrylate” in (B1) or (B2) denotes C₁ to C₈ alkyl methacrylates and acrylates and can be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) can also be crosslinked by any appropriate process or agent (diepoxy, diacid, peroxide, and the like); the term “functionalized polyolefin” also comprises the mixtures of the abovementioned polyolefins with a difunctional reactant, such as diacid, dianhydride, diepoxy, and the like, which is capable of reacting with these abovementioned polyolefins or the blends of at least two functionalized polyolefins which can react together.

The abovementioned copolymers, (B1) and (B2), can be copolymerized in random or block fashion and can exhibit a linear or branched structure.

The molecular weight, the MFI index and the density of these polyolefins can also vary within a broad range, which will be perceived by a person skilled in the art. MFI is the abbreviation for Melt Flow Index. It is measured according to the standard ASTM 1238.

Advantageously, the nonfunctionalized polyolefins (B2) are chosen from propylene homopolymers or copolymers and any ethylene homopolymer or copolymer of ethylene and of a comonomer of higher α-olefin type, such as butene, hexene, octene or 4-methyl-1-pentene. Mention may be made, for example, of PPs, high density PEs, medium density PEs, linear low density PEs, low density PEs or very low density PEs. These polyethylenes are known by a person skilled in the art as being produced according to a “radical” process, according to a catalysis of “Ziegler” type or, more recently, according to a “metallocene” catalysis.

Advantageously, the functionalized polyolefins (B1) are chosen from any polymer comprising α-olefin units and units carrying polar reactive functions, such as epoxy, carboxylic acid or carboxylic acid anhydride functions. Mention may be made, by way of examples of such polymers, of terpolymers of ethylene, of alkyl acrylate and of maleic anhydride or of glycidyl methacrylate, such as the Lotader® products from the applicant company, or polyolefins grafted with maleic anhydride, such as the Orevac® products from the applicant company, and also terpolymers of ethylene, of alkyl acrylate and of (meth)acrylic acid. Mention may also be made of propylene homopolymers or copolymers grafted with a carboxylic acid anhydride and then condensed with monoaminated polyamides or monoaminated polyamide oligomers.

### As Regards the Additives

The additives optionally used in the compositions of the invention are the conventional additives used in polyamides which are well known to a person skilled in the art and are described in particular in EP 2 098 580.

For example, they are chosen from a catalyst, an antioxidant, a heat stabilizer, a UV absorber, a light stabilizer, a lubricant, an inorganic filler, a flame retardant, a nucleating agent and a colorant, reinforcing fibers, a wax and their mixtures.

The term “catalyst” denotes a polycondensation catalyst, such as an inorganic or organic acid.

Advantageously, the proportion by weight of catalyst is of from approximately 50 ppm to approximately 5000 ppm, in particular from approximately 100 ppm to approximately 3000 ppm, with respect to the total weight of the composition.

Advantageously, the catalyst is chosen from phosphoric acid (H₃PO₄), phosphorous acid (H₃PO₃), hypophosphorous acid (H₃PO₂) or a mixture of these.

By way of example, the stabilizer can be a UV stabilizer, an organic stabilizer or more generally a combination of organic stabilizers, such as an antioxidant of phenol type (for example of the type of that of Irganox® 245 or 1098 or 1010 from Ciba-BASF), an antioxidant of phosphite type (for example Irgafos® 126 and Irgafos® 168 from Ciba-BASF) and indeed even optionally other stabilizers, such as a HALS, which means Hindered Amine Light Stabilizer (for example Tinuvin® 770 from Ciba-BASF), a UV absorber (for example Tinuvin® 312 from Ciba) or a phosphorus-based stabilizer. Use may also be made of antioxidants of amine type, such as Naugard® 445 from Crompton, or also of polyfunctional stabilizers, such as Nylostab® S-EED from Clariant.

The stabilizer can also be an inorganic stabilizer, such as a copper-based stabilizer. Mention may be made, as examples of such inorganic stabilizers, of copper halides and acetates. Incidentally, other metals, such as silver, can optionally be considered but these are known to be less effective. These copper-based compounds are typically combined with alkali metal halides, in particular potassium.

### As Regards the Plasticizer

By way of example, the plasticizers are chosen from benzenesulfonamide derivatives, such as n-butylbenzenesulfonamide (BBSA); ethyltoluenesulfonamide or N-cyclohexyltoluenesulfonamide; esters of hydroxybenzoic acids, such as 2-ethylhexyl para-hydroxybenzoate and 2-hexyldecyl para-hydroxybenzoate; esters or ethers of tetrahydrofurfuryl alcohol, such as oligoethyleneoxy-tetrahydrofurfuryl alcohol; and esters of citric acid or of hydroxymalonic acid, such as oligoethyleneoxy malonate.

It would not be departing from the scope of the invention to use a mixture of plasticizers.

The additives, when they are present in the composition, are advantageously present at from 1% to 20% by weight, in particular from 5% to 15% by weight, especially from 5% to 12% by weight.

### As Regards the Antistatic Fillers

The antistatic fillers are, for example, chosen from carbon black, graphite, carbon fibers and carbon nanotubes, in particular carbon black and carbon nanotubes.

### As Regards the Layer (2)

The terms “semicrystalline polyamide” and “aliphatic” have the same definitions as for the layer (1).

Said at least one semicrystalline aliphatic polyamide is obtained in the same way as described above for the layer (1).

In a first alternative form of the layer (2), said layer (2) is devoid of impact modifier.

In this case, the semicrystalline aliphatic polyamide which is PA12 and/or PA612 and/or PA1010 is excluded from the composition which constitutes the layer (2).

In a second alternative form of the layer (2), said layer (2) comprises from 3% to 45% by weight of at least one impact modifier, in particular from 5% to 20% by weight of at least one impact modifier.

In one embodiment of this second alternative form, said layer (2) consists of a composition comprising:
at least 50% by weight, in particular from 50% to 97% by weight, especially from 50% to 95% by weight, of at least one semicrystalline aliphatic polyamide, denoted D, exhibiting a mean number of carbon atoms per nitrogen atom, denoted C_{D}, of from 6 to 18, advantageously from 9 to 15;
from 0% to 25% by weight of at least one semicrystalline aliphatic polyamide denoted E and exhibiting a mean number of carbon atoms per nitrogen atom denoted C_{E}=C_{D}−1, preferentially C_{E}=C_{D}−2;
from 0% to 25% by weight of a semicrystalline aliphatic polyamide denoted F and exhibiting a mean number of carbon atoms per nitrogen atom denoted C_{F}=C_{E}−1, preferentially C_{F}=C_{E}−2;
from 3% to 45% by weight of at least one impact modifier, in particular from 5% to 20% by weight of at least one impact modifier;
from 0% to 20% by weight of at least one plasticizer;
from 0% to 2% by weight of at least one additive;
from 0% to 35% by weight of at least one antistatic filler;
the sum of the constituents being equal to 100%.

In another embodiment of this second alternative form, said layer (2) consists of a composition consisting of:
at least 50% by weight, in particular from 50% to 97% by weight, especially from 50% to 95% by weight, of at least one semicrystalline aliphatic polyamide, denoted D, exhibiting a mean number of carbon atoms per nitrogen atom, denoted C_{D}, of from 6 to 18, advantageously from 9 to 15;
from 0% to 25% by weight of at least one semicrystalline aliphatic polyamide denoted E and exhibiting a mean number of carbon atoms per nitrogen atom denoted C_{E}=C_{D}−1, preferentially C_{E}═C_{D}-2;
from 0% to 25% by weight of a semicrystalline aliphatic polyamide denoted F and exhibiting a mean number of carbon atoms per nitrogen atom denoted C_{F}=C_{E}−1, preferentially C_{F}=C_{E}−2;
from 3% to 45% by weight of at least one impact modifier, in particular from 5% to 20% by weight of at least one impact modifier;
from 0% to 20% by weight of at least one plasticizer;
from 0% to 2% by weight of at least one additive;
from 0% to 35% by weight of at least one antistatic filler;
the sum of the constituents being equal to 100%.

In a further embodiment of this second alternative form, said layer (2) consists of a composition comprising:
at least 50% by weight, in particular from 50% to 97% by weight, especially from 50% to 95% by weight, of at least one semicrystalline aliphatic polyamide, denoted D, exhibiting a mean number of carbon atoms per nitrogen atom, denoted C_{D}, of from 6 to 18, advantageously from 9 to 15;
from 0% to 50% by weight of at least one semicrystalline aliphatic polyamide denoted E and exhibiting a mean number of carbon atoms per nitrogen atom denoted C_{E}=C_{D}−1, preferentially C_{E}═C_{D}-2;
from 0% to 50% by weight of a semicrystalline aliphatic polyamide denoted F and exhibiting a mean number of carbon atoms per nitrogen atom denoted C_{F}=C_{E}−1, preferentially C_{F}═C_{E}-2;
from 3% to 45% by weight of at least one impact modifier, in particular from 5% to 20% by weight of at least one impact modifier;
from 0% to 20% by weight of at least one plasticizer;
from 0% to 2% by weight of at least one additive;
from 0% to 35% by weight of at least one antistatic filler;
the sum of the constituents being equal to 100%.

Advantageously, the composition of said layer (2) comprises a PA11, a PA12 or a PA612 and from 3% to 45% by weight of an impact modifier, in particular from 5% to 20% by weight of an impact modifier.

### As Regards the Structure

All the embodiments of the layer (1) described above in the section “As regards the layer (1)” can be used for the structure described in detail in this part.

Advantageously, said layer (1) is the layer in contact with the transported fluid.

Advantageously, the composition of said layer (2) comprises a PA11, a PA12 or a PA612 and the recycled material originates from a monolayer tube consisting of a composition comprising solely a PA11; in particular, the composition of the layer (1) consists of 100% of recycled material.

Advantageously, the composition of said layer (2) comprises a PA11, a PA12 or a PA612 and the recycled material originates from a monolayer tube comprising a composition comprising solely a PA11; in particular, the composition of the layer (1) consists of 100% of recycled material and the composition of said layer (2) comprises a PA11, a PA12 or a PA612.

Advantageously, the composition of said layer (2) comprises a PA11, a PA12 or a PA612 and from 3% to 45% by weight of at least one impact modifier, in particular from 5% to 20% by weight of at least one impact modifier, and the recycled material originates from a monolayer tube consisting of a composition comprising solely a PA11; in particular, the composition of the layer (1) consists of 100% of recycled material.

In one embodiment, said layer (1) represents at least 10%, especially at least 30%, in particular at least 50%, of the total thickness of said multilayer tubular structure (MLT).

Advantageously, said layer (1) represents at least 60%, in particular at least 70%, of the total thickness of said multilayer tubular structure (MLT).

In one embodiment of the multilayer tubular structure (MLT), said composition of said layer (1) is devoid of polyamides denoted A and B and said composition of said layer (2) comprises polyamides chosen from those denoted E, F and a mixture of these.

In another embodiment of the multilayer tubular structure (MLT), said composition of said layer (1) comprises polyamides chosen from those denoted A, B and a mixture of these, and said composition of said layer (2) is devoid of polyamides denoted E and F.

In yet another embodiment of the multilayer tubular structure (MLT), said composition of said layer (1) comprises polyamides chosen from those denoted A, B and a mixture of these, and said composition of said layer (2) comprises polyamides chosen from those denoted E, F and a mixture of these.

In yet another embodiment of the multilayer tubular structure (MLT), said composition of said layer (1) is devoid of polyamides denoted A and B and said composition of said layer (2) is devoid of polyamides denoted E and F.

Advantageously, in these last four embodiments, the layer (1) originates from a monolayer recycled tube.

Advantageously, in these last four embodiments, the layer (1) originates from a monolayer recycled tube and said composition of said layer (1) alone comprises at least one impact modifier.

Advantageously, in these last four embodiments, the layer (1) originates from a monolayer recycled tube and said composition of said layer (1) and also said composition of the layer (2) comprises at least one impact modifier.

Advantageously, in these last four embodiments, the layer (1) originates from a multilayer recycled tube.

Advantageously, in these last four embodiments, the layer (1) originates from a multilayer recycled tube and said composition of said layer (1) alone comprises at least one impact modifier.

Advantageously, in these last four embodiments, the layer (1) originates from a multilayer recycled tube and said composition of said layer (1) and also said composition of the layer (2) comprises at least one impact modifier.

In one embodiment, said multilayer tubular structure (MLT) is intended for the transportation of fluids chosen from a fuel, such as gasoline, in particular alcohol-blended gasoline or biogasoline, or diesel, in particular biodiesel.

### EXAMPLES

The following resins were used in the various compositions of the invention:

PA11: Polyamide 11 with an Mn (number-average molecular weight) of 29 000. The melting point is 190° C. and its enthalpy of fusion is 56 kJ/m². The composition of this PA11 comprises 0.25% (+/−0.05%) of H₃PO₄.

PA12: Polyamide 12 with an Mn (number-average molecular weight) of 35 000. The melting point is 178° C. and its enthalpy of fusion is 54 KJ/m².

PA1012: Polyamide 1012 with an Mn (number-average molecular weight) of 27 000. The melting point is 190° C. and its enthalpy of fusion is 57 KJ/m².

The melting point and the enthalpy of fusion were determined according to the standard ISO 11357-3:2013.

The following additives, plasticizers and impact modifiers were used in the compositions of the invention:
stabilizer: stabilizer consisting of 80% of phenol Lowinox® 44B25 from Great Lakes and of 20% of phosphite Irgafos® 168 from Ciba.
BBSA: plasticizer BBSA (benzylbutylsulfonamide)
imod=denotes generically an impact modifier of polyolefin or other type, such as, inter alia, PEBAs (polyether-block-amide), core-shell particles, silicones, and the like.
imod1: denotes an EPR functionalized by an anhydride-function reactive group (at 0.5%-1% by weight), with an MFI of 9 (at 230° C., under 10 kg), of Exxellor® VA1801 type from Exxon.
imod2: impact modifier of ethylene/ethyl acrylate/anhydride type in a ratio by weight of 68.5/30/1.5 and MFI 6 at 190° C. under 2.16 kg.
imod3: impact modifier of ethylene/butyl acrylate/anhydride type in a ratio by weight of 79/18/3 and MFI 5 at 190° C. under 2.16 kg.
   The Following Compositions were Used to Manufacture the Tubes According to the Invention:

Throughout the description, all the percentages are given by weight.

In the case of the compositions designated “recy”, “recy2” and “recy3” which are used for the layer (1) of the tubes of the invention or of the counterexample tubes, protocols for simulating an aged tube were used:

Protocol A: The tube is (artificially) aged according to an easily reproducible model protocol which consists in placing it in air (in the presence of oxygen) at 150° C. for 96 h (4 days), in order to thermally oxidize it. This model aging is representative of the average thermal oxidation which the tubes are subjected to in 10 years of service in a vehicle next to a hot engine.

The results obtained with regard to impact, aging, flexural modulus, adhesion and elongation show that the protocol A is representative of a reground gasoline tube.

Specific protocols used during the (re) compounding of the aged tube.

After aging, the ground tube can in some cases be recompounded according to two protocols:

Protocol B: the reground tube is recompounded on a Coperion/Werner® twin-screw extruder, 40 mm, 70 kg/h, 300 rpm, 270° C. of set point, with degassing of −100 mmHg.

Protocol B2: the reground tube is recompounded on a Coperion/Werner® twin-screw extruder, 40 mm, 70 kg/h, 300 rpm, 270° C. of set point, with strong degassing of −660 mmHg.

The various compositions used for the preparation of the tubes of the invention are as follows:

$$PA 11 PL = PA 11 + 7 \% BBSA + 1 \% stabilizer$$

$$PA 12 PL = PA 12 + 12 \% BBSA + 1 \% stabilizer$$

PA11PL-recy=tube of PA11PL aged according to protocol A, reground, to be subsequently recycled
PA11PL-recy2=tube of PA11PL aged according to protocol A, reground, recompounded according to protocol B2, with addition during this recompounding of 7% of BBSA+0.5% of stabilizer, to be subsequently recycled
PA11PL-recy+50% PA12PL-recy=a 50/50 mixture of granules of PA11PL-recy and of PA12PL-recy
PA11PL-recy3=tube of PA11PL aged according to protocol A, reground, recompounded according to protocol B2, recompounding with strong degassing, with addition during this recompounding of 6% of imod3 and 5% of BBSA and of 0.5% of stabilizer
PA12PL-recy=tube of PA12PL aged according to protocol A, reground, to be subsequently recycled

$$PA 12 - i mod 1 = PA 12 + 6 \% i mod 1 + 8 \% BBSA + 1 \% stabilizer$$

$$PA 1012 PL 4 = PA 1012 + 12 \% BBSA + 1 \% stabilizer$$

1012-recy=tube of PA1012PL4 aged according to protocol A, reground, to be subsequently recycled
PA12HIP-recy3=tube of PA12HIPHL aged according to protocol A, reground, recompounded according to protocol B, with addition during this recompounding of 6% imod1, 9% BBSA and 1% stabilizer, being subsequently intended to be recycled

$$PA 11 NX 3 = PA 11 + 10 \% i mod 2 + 5 \% PA 610 + 5 \% PA 6 + 4 \% BBSA + 1 \% stabilizer$$

PA11NX3-recy2=tube of PA11NX3 aged according to protocol A, reground, recompounded according to protocol B2, recompounding with strong degassing, with addition during this recompounding of 3% of BBSA and of 0.5% of stabilizer
PA11PL-recyNX3=tube of PA11PL aged according to protocol A, reground, recompounded according to protocol B, with addition during this recompounding of 10% imod2+5% PA610+5% PA6+4% BBSA+1% stabilizer, to be subsequently recycled

$$PA 12 HIPHL = PA 12 + 6 \% i mod 1 + 10 \% BBSA + 1 \% stabilizer$$

PA12HIPHL-recy2=tube of PA12HIPHL aged according to protocol A, reground, recompounded according to protocol B, with addition during this recompounding of 10% of BBSA+0.5% of stabilizer, to be subsequently recycled
PA12HIP-recy3=tube of PA12HIPHL aged according to protocol A, reground, recompounded according to protocol B, with addition during this recompounding of 6% imod1, 9% BBSA and 1% stabilizer, being subsequently intended to be recycled

These compositions are manufactured by conventional compounding in a corotating twin-screw extruder of the Coperion® 40 type, at 300 rpm, at 270° C. (or at 300° C. when the ingredients have a melting point of greater than 260° C.).

### Multilayer Tubes of the Invention:

The layers are described from the outside toward the inside, followed by their respective thicknesses indicated in the form of %; the tubes have dimensions of 8×1 mm.

Preparation of the multilayer structures (tubes):

The multilayer tubes are produced by coextrusion. A Maillefer® multilayer extrusion industrial line, equipped with 5 extruders connected to a multilayer extrusion head having spiral mandrels, is used.

The screws used are single extrusion screws having screw profiles suited to polyamides. In addition to the 5 extruders and the multilayer extrusion head, the extrusion line comprises:
a die-punch assembly, located at the end of the coextrusion head; the internal diameter of the die and the external diameter of the punch are chosen as a function of the structure to be produced and of the materials of which it is composed, and also of the dimensions of the tube and of the line speed;
a vacuum tank with an adjustable level of vacuum. Water maintained in general at 20° C. circulates in this tank, into which water a gauge is immersed which makes it possible to form the tube into its final dimensions. The diameter of the gauge is suited to the dimensions of the tube to be produced, typically from 8.5 to 10 mm for a tube with an external diameter of 8 mm and with a thickness of 1 mm;
a succession of cooling tanks in which water is maintained at approximately 20° C., making it possible to cool the tube along the path from the head to the drawing bench;
a diameter measurer;
a drawing bench.

The configuration having 5 extruders is used to produce tubes ranging from 2 layers to 5 layers (and also monolayer tubes).

Before the tests, in order to provide the tube with the best properties and a good extrusion quality, it is verified that the extruded materials have a residual moisture content before extrusion of less than 0.08%. If this is not the case, an additional stage of drying the material before the tests is carried out, generally in a vacuum dryer, overnight at 80° C.

The tubes, which satisfy the characteristics described in the present patent application, were removed, after stabilization of the extrusion parameters, the targeted dimensions of the tubes no longer changing over time. The diameter is monitored by a laser diameter measurer installed at the end of the line.

The line speed is typically 20 m/min. It generally varies between 5 and 100 m/min.

The screw speed of the extruders depends on the thickness of the layer and on the diameter of the screw, as is known to a person skilled in the art.

In general, the temperatures of the extruders and items of equipment (head and connector) should be adjusted so as to be sufficiently greater than the melting point of the compositions under consideration, so that they remain in the molten state, thus preventing them from solidifying and blocking the machine.

The multilayer tubes produced by extrusion above were subsequently evaluated with regard to several criteria:
Flexural modulus (Flex.): designates the flexural modulus measured according to ISO178 at 23° C. on a tube conditioned at equilibrium in a climate of 50% humidity and at 23° C.
“+” denotes a flexibility which can be described as “good”, which corresponds to <=1000 MPa and >500 MPa
“++” denotes a flexibility which can be described as “very good”, which corresponds to <=500 MPa and >250 MPa
Impact: denotes the impact of VW−40° C. type standard VW TL52435.2010
“++” denotes an impact performance which can be described as “very good”, which corresponds to <=10% of breakage
“+” denotes an impact performance which can be described as “good”, which corresponds to <=25% of breakage and >10% of breakage
“−” denotes an impact performance which can be described as “rather poor”, which corresponds to <=75% of breakage and >25%
“−−” denotes an impact performance which can be described as “very poor”, which corresponds to >75%
Aging (Ag.): this is the durability: in other words, this denotes the resistance of the tube to oxidative aging in hot air. The tube is aged in air at 150° C. and then it is impacted with an impact according to the standard DIN 73378, this impact being produced at −40° C.; the half-life (in hours), which corresponds to the time at the end of which 50% of the tubes tested have broken, is shown. A qualitative comment accompanies this value.
A “++” grading is given for a durability which can be described as “very good”, which corresponds to a half-life>=200 h
A “+” grading is given for a durability (resistance to thermal oxidative aging) which can be described as “good”, which corresponds to a half life>=100 h (and <200 h)
A “+−” grading is given for a durability (resistance to thermal oxidative aging) which can be described as “acceptable”, which corresponds to a half-life>=50 h (and <100 h).
A “−” grading is given for a durability (resistance to thermal oxidative aging) which can be described as “poor”, corresponding to <50 h.

In the cases where a half-life figure is given to show nuances, this figure is rounded off to 25 h, to take account of significant figures, linked to the precision of the evaluation.

Adhesion (Adh.): this is the adhesiveness. It is reflected in the measurement of the peel strength, expressed in N/cm and measured on the tube with a diameter of 8 mm and a thickness of 1 mm which has been subjected to conditioning for >=15 days at 50% relative humidity at 23° C., such that hygroscopic equilibrium is reached within the sample.

The value given relates to the weakest interface, that is to say the least adherent interface of the multilayer, the place where there is thus the greatest risk of detachment. Peeling is carried out at the interface by subjecting one of the parts to traction at an angle of 90° and at a rate of 50 mm/min according to the following process.

A strip of tube with a width of 9 mm is removed by cutting out. This strip is thus tile-shaped and still has all the layers of the original tube. The separation of the two layers of the interface, which it is desired to evaluate, is initiated by means of a knife. Each of the layers thus separated is placed in the jaws of a tensile testing device. Peeling is carried out by applying traction to these 2 layers on either side at 180 degrees and at a rate of 50 mm/min. The strip, and thus the interface, is for its part maintained at 90 degrees with respect to the direction of traction.

The following gradings are given:
+++: very good, >50
++: good, >20 and <=50
+: fairly good (acceptable), >10 and <=20
−: poor, <=10

Elongation at break (El. %); this is the elongation at break produced according to the standard ISO R527, except that the measurement is carried out on a tube with a diameter of 8 mm and a thickness of 1 mm. The sample is ISO-conditioned; this is a conditioning of >=15 days at 50% relative humidity at 23° C. such that hygroscopic equilibrium is reached within the sample.

The following gradings are given:
+++: very good, >=200% elongation
++: good, >=100 and <200% elongation
+: not very satisfactory: <100% elongation

The results are shown in table 1.

TABLE 1

| | Structure and thickness of the | | | | | |
|---|---|---|---|---|---|---|
| Example | layers (as % of the total thickness) | Impact | Ag. | Flex. | Adh. | El. % |
| Ex. 1 | PA12imod1//PA11PL-recyNX3 15/85% | ++ | + | ++ | +++ | +++ |
| Ex. 2 | PA12imod1//PA11PL-recy3 15/85% | ++ | + | ++ | +++ | +++ |
| Ex. 3 | PA12imod1//11NX3-recy2 15/85% | ++ | + | ++ | +++ | +++ |
| Ex. 4 | PA12imod1//PA12HIPHL-recy2 15/85% | ++ | + | ++ | +++ | +++ |
| Ex. 5 | PA12imod1//PA12HIP-recy3 15/85% | ++ | + | ++ | +++ | +++ |
| Ex. 6 | 11NX3//11NX3-recy2 15/85% | ++ | ++ | ++ | +++ | +++ |
| Counter examples | | | | | | |
| Cx. 1 | PA12imod1//PA11PL-recy 15/85% | + | + | + | +++ | +++ |
| Cx. 2 | PA12imod1//PA12HIPHL-recy 15/85% | + | +− | + | +++ | +++ |
| Cx. 3 | PA12PL-recy monolayer | −− | − | + | NT | + |
| Cx. 4 | PA11PL-recy monolayer | + | − | ++ | NT | + |
| Cx. 5 | PA11PL-recy2 monolayer | ++ | − | ++ | NT | ++ |
| Cx. 6 | PA12HIP-recy3 monolayer | + | − | ++ | NT | ++ |
| Cx. 7 | 1012-recy monolayer | − | − | + | NT | + |

NT: not tested

1. A multilayer tubular structure (MLT) intended for the transportation of motor vehicle fluids, the MLT consisting of two layers:
a layer (1) consisting of a composition predominantly comprising at least one semicrystalline aliphatic polyamide, said composition consisting of at least 50% of recycled material originating from a monolayer and/or multilayer tube having been intended for the transportation of motor vehicle fluids, said tube consisting of a composition which predominantly comprises at least one polyamide,
said tube having undergone various treatments chosen from a grinding and then a recompounding, wherein after grinding, the ground particles are fed into an extruder, where they are remixed by melting, and a grinding, then a recompounding and subsequently a reformulation, in order to be able to be recycled,
a simple single grinding being excluded from the various treatments,
a layer (2) consisting of a composition predominantly comprising at least one semicrystalline aliphatic polyamide and optionally at least one impact modifier,
and, when the layer (2) consists of a composition predominantly comprising at least one semicrystalline aliphatic polyamide which is PA12 and/or PA612 and/or PA1010, then said composition comprises said impact modifier, and
said layer (2) consisting of at least 90% of nonrecycled material.

2. The multilayer tubular structure (MLT) as claimed in claim 1, in which the layer (1) is the layer in contact with the fluid.

3. The multilayer tubular structure (MLT) as claimed in claim 1, in which said layer (1) represents at least 10% of the total thickness of said multilayer tubular structure (MLT).

4. The multilayer tubular structure (MLT) as claimed in claim 1, in which said layer (1) consists of a composition comprising:
at least 50% by weight of at least one semicrystalline aliphatic polyamide, denoted C, exhibiting a mean number of carbon atoms per nitrogen atom, denoted CC, of from 6 to 18;
from 0% to 25% by weight of at least one semicrystalline aliphatic polyamide denoted B and exhibiting a mean number of carbon atoms per nitrogen atom denoted C_{B}═CC−1;
from 0% to 25% by weight of a semicrystalline aliphatic polyamide denoted A and exhibiting a mean number of carbon atoms per nitrogen atom denoted C_{A}=C_{B}−1;
from 0% to 45% by weight of at least one impact modifier;
from 0% to 20% by weight of at least one plasticizer;
from 0% to 2% by weight of at least one additive;
the sum of the constituents being equal to 100%.

5. The multilayer tubular structure (MLT) as claimed in claim 1, in which the recycled material originates from a monolayer and/or multilayer tube chosen from a ground and recompounded monolayer and/or multilayer tube and a ground, recompounded and reformulated monolayer and/or multilayer tube.

6. The multilayer tubular structure (MLT) as claimed in claim 5, in which said composition of the layer (1) is devoid of plasticizer and/or of impact modifier and said recycled material originates from a monolayer and/or multilayer tube chosen from a ground and recompounded monolayer and/or multilayer tube and a ground, recompounded and reformulated monolayer and/or multilayer tube.

7. The multilayer tubular structure (MLT) as claimed in claim 5, in which said composition of the layer (1) comprises at least one compound chosen from a plasticizer, an impact modifier and an additive, and said recycled material originates from a ground, then recompounded and reformulated, monolayer and/or multilayer tube.

8. The multilayer tubular structure (MLT) as claimed in claim 1, in which the fluid transported by said monolayer and/or multilayer tube is the same as that of said multilayer tubular structure (MLT).

9. The multilayer tubular structure (MLT) as claimed in claim 1, in which the fluid transported by said monolayer and/or multilayer tube is different from that of said multilayer tubular structure.

10. The multilayer tubular structure (MLT) as claimed in claim 1, in which the layer (2) consists of a composition comprising:
at least 50% by weight of at least one semicrystalline aliphatic polyamide, denoted D, exhibiting a mean number of carbon atoms per nitrogen atom, denoted C_{D}, of from 6 to 18;
from 0% to 50% by weight of at least one semicrystalline aliphatic polyamide denoted E and exhibiting a mean number of carbon atoms per nitrogen atom denoted C_{E}═C_{D}-1;
from 0% to 50% by weight of a semicrystalline aliphatic polyamide denoted F and exhibiting a mean number of carbon atoms per nitrogen atom denoted C_{F}═C_{E}-1;
from 3% to 45% by weight of at least one impact modifier;
from 0% to 20% by weight of at least one plasticizer;
from 0% to 2% by weight of at least one additive;
from 0% to 35% by weight of at least one antistatic filler;
the sum of the constituents being equal to 100%.

11. The multilayer tubular structure (MLT) as claimed in claim 10, in which said composition of said layer (1) is devoid of polyamides denoted A and B and said composition of said layer (2) comprises polyamides chosen from those denoted E, F and a mixture of these.

12. The multilayer tubular structure (MLT) as claimed in claim 10, in which said composition of said layer (1) comprises polyamides chosen from those denoted A, B and a mixture of these, and said composition of said layer (2) is devoid of polyamides denoted E and F.

13. The multilayer tubular structure (MLT) as claimed in claim 10, in which the layer (1) originates from a monolayer recycled tube.

14. The multilayer tubular structure (MLT) as claimed in claim 10, in which said tube is a multilayer tube.

15. The multilayer tubular structure (MLT) as claimed in claim 1, in which the Tm of the predominant semicrystalline aliphatic polyamide of the layer (1) is ≤225° C., as determined by DSC according to the standard ISO 11357-3:2013, at a heating rate of 20 K/min.

16. The multilayer tubular structure (MLT) as claimed in claim 1, in which the predominant semicrystalline aliphatic polyamide of the layer (1) exhibits an enthalpy of crystallization ≥25 J/g, as determined by DSC according to the standard ISO 11357-3:2013, at a heating rate of 20 K/min.
